(19) United States
(12) Patent Application Publication
(10) Pub. No.: US 2014/0080741 A1
(43) Pub. Date: Mar. 20, 2014

(54) FERROSILICON WEIGHTING AGENTS FOR WELLBORE FLUIDS

(71) Applicants: Thomas Parias, Rhodes Sint Genesius (BE); Jonathan Stuart Phipps, Cornwall (GB); Jarrod Hart, Cornwall (GB); Mark Windebank, Cornwall (GB); Christopher Bean, Los Alamos, CA (US)

(72) Inventors: Thomas Parias, Rhodes Sint Genesius (BE); Jonathan Stuart Phipps, Cornwall (GB); Jarrod Hart, Cornwall (GB); Mark Windebank, Cornwall (GB); Christopher Bean, Los Alamos, CA (US)

(73) Assignee: Imerys Oilfield Minerals, Inc., Roswell, GA (US)

(21) Appl. No.: 13/879,578

(22) PCT Filed: Oct. 13, 2011
(86) PCT No.: PCT/EP2011/067879

§ 371 Date: Nov. 26, 2013

(30) Foreign Application Priority Data
Oct. 13, 2010 (EP) 10290551.0

(51) Int. Cl. C09K 8/03

(52) U.S. Cl. CPC C09K 8/032
USPC 507/143; 428/402; 420/8; 241/30

(57) ABSTRACT

A weighting agent for use in a wellbore fluid composition is provided. The weighting agent includes a ferrosilicon material, wherein iron is present in the ferrosilicon material in an amount equal to or greater than about 50% by weight of the ferrosilicon material. A composition including a wellbore fluid and a weighting agent, as well as methods for using and making a weighting agent, are also provided.

### FIELD OF THE DISCLOSURE

The present disclosure relates to ferrosilicon weighting agents for use in wellbore fluids.

### BACKGROUND

In oil drilling applications, weighting agents may be used in oilfield drilling and cementing fluids to raise the fluid density. Liquid drilling fluid is often referred to as drilling mud. The three main types of drilling fluids are water-based muds (which can be dispersed and non-dispersed), non-aqueous muds, usually called oil-based muds, and gaseous drilling fluids. The drilling fluids function to provide hydrostatic pressure to prevent subterranean fluids (e.g., gas, water, and/or oil) from entering the wellbore, to prevent collapse of the wellbore, to keep the drill bit cool and clean during drilling, to carry out drill cuttings, and to suspend the drill cuttings while drilling is stopped. After drilling, a tubular steel casing is typically lowered into the wellbore, and a cementing fluid is pumped down the center of the casing and up into the annular space between the casing and the wellbore. The cementing fluid then sets into a strong, impermeable solid which holds the casing in place and seals the annular space, thus preventing passage of fluids along the wellbore on the outside of the casing.

The hydrostatic pressure provided by the drilling or cementing fluid, that is required to prevent invasion of subterranean fluids into the wellbore and/or to prevent the collapse of the wellbore, is dependent upon the fluid's density. It is usually advantageous to raise the density of the fluid above the level of the base liquid (e.g., water, brine or oil) from which it is made by adding a weighting agent. The weighting agents used in drilling or cementing fluids are generally inorganic particulate materials that are suspended in the fluids. In order to achieve high fluid densities of 1.5 g/cm³ or more, particulate weighting agents may be added to the drilling fluids in significant quantities, which normally amount to more than 15% of the fluid by volume. However, the presence of a high volume fraction of solids may be detrimental to the performance of the drilling fluid, in particular its rheological profile. Thus, it would be advantageous to achieve a desired fluid density with a low volume fraction of suspended particles.

Previously, the use of weighting agents including particles less than 5 microns in size has been avoided by the industry because of the increased difficulty in keeping the particles dispersed in the wellbore fluid as compared with coarser particles. More recently, finer sub-micron sized particles have been introduced as weighting agents as methods for dispersing them have improved.

Barite (i.e., barium sulphate) is commonly used in drilling fluids as a weighting agent. Pure barite has a density of 4.4 g/cm³, but most commercial grades have a density of 4.2 g/cm³ since they contain a small amount of much lower density quartz and other impurities. Recently, the industry minimum specification (API standard) for barite density has had to be reduced to 4.1 g/cm³ to increase the range of barite sources that may be used and to allow the demand for barite weighting agents to be met. Other materials such as haematite (with a density of 5.3 g/cm³) and ilmenite (with a density of 4.8 g/cm³) also may be used as weighting agents. In oil well cements, the use of denser materials such as haematite is more common, because the solids loading of the cement may be typically much higher than for a drilling fluid. However, since there is a higher solids loading, the volume of weighting agent that can be accommodated in the cementing fluid is more restricted.

Though iron has a much higher density (e.g., 7.9 g/cm³) than barite, powdered iron is not used as a weighting agent in drilling or cementing fluids because conventional grinding methods are typically not used for grinding iron to a fine powder, as the iron is too hard and insufficiently brittle. Although powdered iron with a median particle size less of than 50 μm is available and is used in powder metallurgy, this powdered iron is produced by very expensive techniques such as chemical vapor deposition or the chemical reduction of pre-ground iron oxide powders (see for example U.S. Pat. No. 5,713,982), making it impractical for use as a weighting agent for drilling fluids. Powdered iron is also a potentially explosive, and thus hazardous, material.

Thus, it may be desirable to provide weighting agents that are inexpensive and abundant, and yet overcome the aforementioned disadvantages.

### SUMMARY

In the following description, certain aspects and embodiments will become evident. It should be understood that the aspects and embodiments, in their broadest sense, could be practiced without having one or more features of these aspects and embodiments.

One aspect of the disclosure relates to a composition for use in a wellbore including a wellbore fluid and a weighting agent. The weighting agent comprises a ferrosilicon material. In certain embodiments, iron is present in the ferrosilicon material in an amount equal to or greater than about 50% by weight of the ferrosilicon material.

Another aspect of the disclosure relates to a weighting agent including a ferrosilicon material having iron present in the ferrosilicon material in an amount equal to or greater than about 50% by weight of the ferrosilicon material. The weighting agent is for use in a wellbore fluid composition.

In still another aspect of the disclosure, a method for reducing the solids content of a wellbore fluid composition is provided. The method comprises providing a weighting agent including ferrosilicon material in a wellbore fluid. In certain embodiments, iron is present in the ferrosilicon material in an amount equal to or greater than about 50% by weight of the ferrosilicon material.

In yet another aspect of the disclosure, a method for making a weighting agent for use in a wellbore fluid composition is provided. The method comprises grinding a ferrosilicon material. In certain embodiments, iron is present in the ferrosilicon material in an amount equal to or greater than about 50% by weight of the ferrosilicon material.

In another aspect of the disclosure, a method for treating a wellbore is provided. The method comprises providing a wellbore fluid composition in the wellbore. The wellbore fluid composition includes a weighting agent comprising a ferrosilicon material, wherein iron is present in the ferrosilicon material in an amount equal to or greater than about 50% by weight of the ferrosilicon material.

It is to be understood that both the foregoing general description and the following detailed description are exemplary and explanatory only and are not restrictive of the invention, as claimed.

The accompanying drawings, which are incorporated in and constitute a part of this specification, illustrate exemplary embodiments of the invention and together with the description, may serve to explain some exemplary principles of the invention.

### BRIEF DESCRIPTION OF THE DRAWINGS

FIG. 1 is a graph of the particle size distribution of an embodiment of the weighting agent made in Example 1.

FIG. 2 is a graph of the particle size distribution of an embodiment of the weighting agent (Sample 2a) made in Example 2.

FIG. 3 is a graph of the particle size distribution of another embodiment of the weighting agent (Sample 2b) made in Example 2.

FIG. 4 is a graph of the particle size distribution of an embodiment of the weighting agent produced by combining Samples 2a and 2b to form Sample 2c made in Example 2.

### DESCRIPTION OF EXEMPLARY EMBODIMENTS

### Weighting Agents

According to some exemplary embodiments, high density ferrosilicon (FeSi) materials may be used in relatively small quantities as weighting agents in wellbore fluids of moderate density. Ferrosilicon is an alloy of iron and silicon. Ferrosilicon may have a variable composition, and in some embodiments the ferrosilicon material contains between 10% and 85% by weight iron and has a density ranging from about 2.4 g/cm³ to about 7 g/cm³. In one embodiment, the weighting agent is a ferrosilicon material including iron in an amount equal to or greater than about 50% by weight of the ferrosilicon material. In certain embodiments, the weighting agent is a ferrosilicon material including iron in an amount equal to or greater than about 55% by weight of the ferrosilicon material. In some embodiments, the ferrosilicon material may include iron in an amount equal to or greater than about 60% by weight of the ferrosilicon material. In another embodiment, the ferrosilicon material may include iron in an amount equal to or greater than about 65% by weight of the ferrosilicon material. In yet another embodiment, the ferrosilicon material may include iron in an amount equal to or greater than about 70% by weight of the ferrosilicon material. In still another embodiment, the ferrosilicon material may include iron in an amount equal to or greater than about 75% by weight of the ferrosilicon material. In certain embodiments, the weighting agent is a ferrosilicon material including iron in an amount equal to or greater than about 80% by weight of the ferrosilicon material. In other embodiments, the weighting agent is a ferrosilicon material including iron in an amount equal to or greater than about 85% by weight of the ferrosilicon material.

In certain embodiments, the ferrosilicon material has a density equal to or greater than about 5 g/cm³. In one embodiment, the ferrosilicon material has a density equal to or greater than about 5.5 g/cm³. In another embodiment, the ferrosilicon material has a density equal to or greater than about 6.0 g/cm³. In yet another embodiment, the ferrosilicon material has a density equal to or greater than about 6.5 g/cm³. In still another embodiment, the ferrosilicon material has a density equal to or greater than about 7.0 g/cm³. In one embodiment, the ferrosilicon material has a density equal to or greater than about 7.5 g/cm³. In other embodiments, the ferrosilicon material has a density equal to or greater than about 8.0 g/cm³. In certain embodiments, the ferrosilicon material has a density ranging from about 6.7 g/cm³ to about 7.0 g/cm³. The higher the density of the weighting agent, the higher the achievable density of the wellbore fluid into which the weighting agent is added.

In certain embodiments, the ferrosilicon material includes silicon in an amount ranging from about 13% to about 18% by weight of the ferrosilicon material. It should be understood that in particular embodiments, the weighting agent and/or the ferrosilicon material may include additional components or impurities. For instance, the ferrosilicon material may include additional compounds such as alumina, silica, titanium, or combinations thereof. In some embodiments, the weighting agent may consist of or consist essentially of a ferrosilicon material such that the weighting agent has a higher density than a weighting agent comprising additional compounds or elements. Exemplary advantages resulting from the weighting agent having a higher density are discussed in further detail herein below.

According to particular embodiments, the ferrosilicon material comprises particles having a median particle size (d₅₀) less than about 100 μm, as measured by laser light scattering using a CILAS 1064 instrument. In certain embodiments, the ferrosilicon material comprises particles having a d₅₀ less than about 90 μm, as measured by laser light scattering using a CILAS 1064 instrument. In some embodiments, the ferrosilicon material comprises particles having a d₅₀ less than about 80 μm, as measured by laser light scattering using a CILAS 1064 instrument. In other embodiments, the ferrosilicon material comprises particles having a d₅₀ less than about 70 μm, as measured by laser light scattering using a CILAS 1064 instrument. In still other embodiments, the ferrosilicon material comprises particles having a d₅₀ less than about 60 μm, as measured by laser light scattering using a CILAS 1064 instrument. In another embodiment, the ferrosilicon material comprises particles having a d₅₀ less than about 50 μm, as measured by laser light scattering using a CILAS 1064 instrument. In yet another embodiment, the ferrosilicon material comprises particles having a d₅₀ less than about 40 μm, as measured by laser light scattering using a CILAS 1064 instrument. In one embodiment, the ferrosilicon material comprises particles having a d₅₀ less than about 30 μm, as measured by laser light scattering using a CILAS 1064 instrument. In another embodiment, the ferrosilicon material comprises particles having a d₅₀ less than about 20 μm, as measured by laser light scattering using a CILAS 1064 instrument. In other embodiments, the ferrosilicon material comprises particles having a d₅₀ less than about 10 μm, as measured by laser light scattering using a CILAS 1064 instrument. In another embodiment the ferrosilicon material comprises particles having a d₅₀ ranging from about 2 μm to about 100 μm, as measured by laser light scattering using a CILAS 1064 instrument. In yet another embodiment, embodiment the ferrosilicon material comprises particles having a d₅₀ greater than about 5 μm, as measured by laser light scattering using a CILAS 1064 instrument.

According to particular embodiments, the ferrosilicon material comprises d₉₀ less than about 200 μm, as measured by laser light scattering using a CILAS 1064 instrument. In other embodiments, the ferrosilicon material comprises particles having a d₉₀ less than about 100 μm, as measured by laser light scattering using a CILAS 1064 instrument. In another embodiment, the ferrosilicon material comprises particles having a d₉₀ ranging from about 30 μm to about 50 μm, as measured by laser light scattering using a CILAS 1064 instrument. In yet another embodiment, the ferrosilicon material comprises particles having a d₉₀ ranging from about 10 μm to about 30 μm, as measured by laser light scattering using a CILAS 1064 instrument.

According to particular embodiments, the ferrosilicon material comprises particles having a steepness equal to or greater than about 20, as measured by laser light scattering using a CILAS 1064 instrument. In other embodiments, the ferrosilicon material comprises particles having a steepness equal to or greater than about 30, as measured by laser light scattering using a CILAS 1064 instrument. In another embodiment the ferrosilicon material comprises particles having a steepness equal to or greater than about 40, as measured by laser light scattering using a CILAS 1064 instrument. Particle steepness (i.e., the steepness of the particle size distribution) is determined by the following formula:

Steepness=100×(d₃₀/d₇₀)

In one embodiment, the ferrosilicon material is a powder or particles produced by dry grinding in a mill, for example, a ball mill. For example, the ferrosilicon material may be ground in the presence of grinding media (e.g., alumina balls). In another embodiment, the ferrosilicon material is made by electrofusing scrap iron/steel and quartz, then “atomizing” (e.g., spray cooling the molten material) and/or grinding the ferrosilicon material. In one embodiment, the ferrosilicon material is made from iron and silica in a blast furnace using coke.

In certain embodiments, the ferrosilicon material is a by-product from the production of brown fused alumina (BFA). For instance, the ferrosilicon material may be a by-product from production of brown fused alumina containing from about 78 wt. % to about 86 wt. % iron, from about 13 wt. % to about 18 wt. % silicon, from about 1 wt. % to about 5 wt.% titanium, and from about 0 wt. % to about 2 wt. % of additional impurities. In particular embodiments, a ferrosilicon by-product from a process for making brown fused alumina is crushed and then ground to produce a weighting agent. Thus, particular embodiments of the ferrosilicon material of the present invention may be derived at little or no cost from a process where the ferrosilicon material is a by-product or waste material.

### Wellbore Fluids

In another aspect of the invention, wellbore fluids including weighting agents comprised of particular embodiments of the ferrosilicon materials described herein are provided. In certain embodiments, the wellbore fluid comprises a drilling fluid, a cementing fluid, or a kill fluid. As used herein, “kill fluid” or “kill mud” refers to a fluid used in a wellbore to prevent the flow of reservoir fluids by suppressing the pressure of the reservoir fluids (e.g., formation fluids such as oil or natural gas). In some embodiments, the drilling fluid comprises an oil-based drilling fluid or a water-based drilling fluid.

In particular embodiments, the wellbore fluid used may have a fluid density ranging from about 1.2 g/cm³ to about 3 g/cm³. For example, a drilling fluid may have a fluid density ranging from about 1.5 g/cm³to about 2.5 g/cm³.

In certain embodiments, a composition comprising a wellbore fluid and a weighting agent has a fluid density equal to or greater than about 1.5 g/cm³. In other embodiments, a composition comprising a wellbore fluid and a weighting agent has a fluid density equal to or greater than about 2.0 g/cm³.

In particular embodiments, a composition is provided comprising a wellbore fluid and a weighting agent, wherein the composition has a solids content equal to or less than about 50% by volume of the composition. In another embodiment, the composition comprising a wellbore fluid and a weighting agent has a solids content equal to or less than about 35% by volume of the composition. In one embodiment, the composition comprising a wellbore fluid and a weighting agent has a solids content equal to or less than about 30% by volume of the composition. In other embodiments, the composition comprising a wellbore fluid and a weighting agent has a solids content equal to or less than about 25% by volume of the composition. In another embodiment, the composition comprising a wellbore fluid and a weighting agent has a solids content equal to or less than about 15% by volume of the composition. In yet another embodiment, the composition comprising a wellbore fluid and a weighting agent has a solids content equal to or less than about 10% by volume of the composition. In still another embodiment, the composition comprising a wellbore fluid and a weighting agent has a solids content equal to or less than about 5% by volume of the composition.

Thus, in certain embodiments, the composition comprising a wellbore fluid and a weighting agent has a fluid density equal to or greater than about 1.5 g/cm³ and a solids content equal to or less than about 25% by volume of the composition. In other embodiments, the composition comprising a wellbore fluid and a weighting agent has a fluid density equal to or greater than about 2.0 g/cm³ and a solids content equal to or less than about 25% by volume of the composition.

In particular embodiments, the drilling fluids including a ferrosilicon material has a fluid density equal to or greater than about 1.5 g/cm³ and a solids content equal to or less than about 30% by volume of the composition. In other embodiments, the cementing fluids including a ferrosilicon material has a fluid density equal to or greater than about 2.0 g/cm³ and a solids content equal to or less than about 60% by volume of the composition. In still other embodiments, the kill fluids including a ferrosilicon material has a fluid density equal to or greater than about 2.0g/cm³ and a solids content equal to or less than about 60% by volume of the composition.

### Methods for Using the Weighting Agents

In another aspect of the present invention, a method for reducing the solids volume fraction in a composition for use in well drilling, construction, or control is provided. In particular embodiments, the method comprises providing a weighting agent comprising embodiments of the ferrosilicon material described herein in the wellbore composition.

In certain embodiments, the weighting agent may be provided in a wellbore fluid to provide a composition having a fluid density equal to or greater than about 1.5 g/cm³. In other embodiments, the composition comprising a wellbore fluid and a weighting agent has a fluid density equal to or greater than about 2.0 g/cm³.

In particular embodiments, the composition comprising a wellbore fluid and a weighting agent has a solids content equal to or less than about 25% by volume of the composition. In other embodiments, the composition comprising a wellbore fluid and a weighting agent has a solids content equal to or less than about 20% by volume of the composition. In another embodiment, the composition comprising a wellbore fluid and a weighting agent has a solids content equal to or less than about 15% by volume of the composition. In yet another embodiment, the composition comprising a wellbore fluid and a weighting agent has a solids content equal to or less than about 10% by volume of the composition. In still another embodiment, the composition comprising a wellbore fluid and a weighting agent has a solids content equal to or less than about 5% by volume of the composition.

Thus, in certain embodiments, the weighting agent may be provided in a wellbore fluid to provide a composition having a fluid density equal to or greater than about 1.5 g/cm³ and a solids content equal to or less than about 25% by volume of the composition. In other embodiments, the composition comprising a wellbore fluid and a weighting agent has a fluid density equal to or greater than about 2.0 g/cm³ and a solids content equal to or less than about 25% by volume of the composition. In still other embodiments, the composition comprising a wellbore fluid and a weighting agent has a fluid density equal to or greater than about 2.0 g/cm³ and a solids content equal to or less than about 50% by volume of the composition.

In certain embodiments, the weighting agent would be used for very deep wells (e.g., high temperature high pressure (HTHP)), which are found in many places around the world (e.g., where there is deep sea drilling or underground drilling).

Without being bound by a particular theory, it is believed that the ferrosilicon material used as a weighting agent has a particle size, density, and loading (among other variables) that allows the weighting agent to be suspended in a wellbore fluid and assist in generating hydrostatic pressure as needed in well drilling applications (e.g., oil well drilling). In some embodiments, the weighting agents have a particle size that allows the formulation of a wellbore fluid with a viscosity low enough to allow it to be circulated easily through the wellbore while still being high enough to suspend the particles. The sedimentation of the particles should be kept to a minimum, as particles which settle on the bottom or sides of a wellbore no longer contribute to the hydrostatic pressure exerted by the fluid. Accordingly, embodiments of the weighting agent desirably would have a density and particle size distribution, among other characteristics, which would result in a composition having low sedimentation when the weighting agent is added to a wellbore fluid and the composition is circulated into a wellbore. For instance, the composition comprising the wellbore fluid and the weighting agent may be substantially homogeneous. The particle sedimentation rate can be reduced either by increasing the low-shear viscosity of the fluid (which may be detrimental to its performance), or by reducing the size of the particles.

In other embodiments, the weighting agents have a density such that the fluid density of the wellbore fluid containing the weighting agent is increased to a desired fluid density without detrimentally increasing the solids content of the wellbore fluid (i.e., the wellbore fluid will still function as desired). For example, a cementing fluid starting with a fluid density of about 2.0 g/cm³ and a solids content of about 45% by volume of the composition may have its fluid density increased to about 2.5 g/cm³ by substitution of part of the cement with a weighting agent comprising a ferrosilicon material such that the solids volume fraction the composition remains constant at 45%.

### EXAMPLES

The laser light scattering measurement method used herein for making particle size measurements is a well known particle size analysis using a CILAS (Compagnie Industrielle des Lasers) 1064 instrument. The CILAS instrument determines the particle size distribution of a sample by passing a laser beam through a dilute suspension of sample particles and measuring the resultant diffraction pattern of the laser beam. The diffraction pattern is then analyzed using mathematical algorithms (Fraunhofer) based on optical theory to calculate the particle size distribution of the sample. The CILAS 1064 instrument was equipped with a wet sampling device and dual laser detection system to allow accurate measurement of very fine particles. The CILAS 1064 instrument normally provides particle size data to two decimal places.

### Example 1

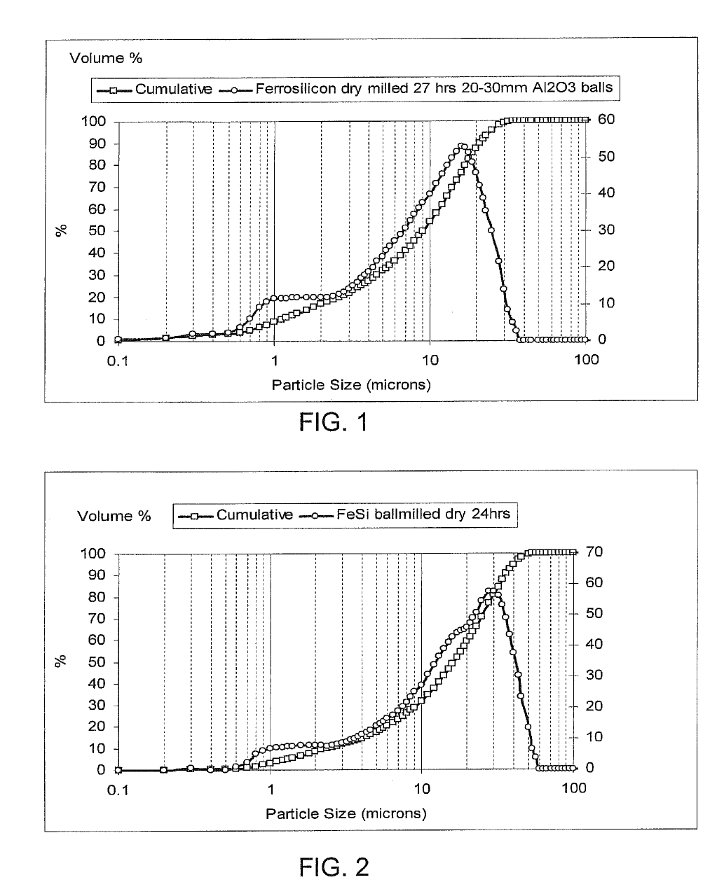

Ferrosilicon with an iron content of approximately 82% by weight and a density of 6.7 g/cm³ was crushed in a jaw crusher to chips of maximum diameter of 6 mm. 1 kg of chips were placed in a cylindrical, 20 cm diameter sealed ceramic vessel which had been approximately half-filled with 15 mm to 25 mm diameter alumina (Al₂O₃) balls, and the cylinder was rotated steadily at a rotational speed of 120 rpm for 27 hrs to grind the chips to a powder. Upon separation from the balls, the powder was analyzed by laser light scattering and was shown to have a median particle size of 9 μm. The particle size distribution as measured by laser light scattering is shown in Table 1 below and in FIG. 1.

### Example 2

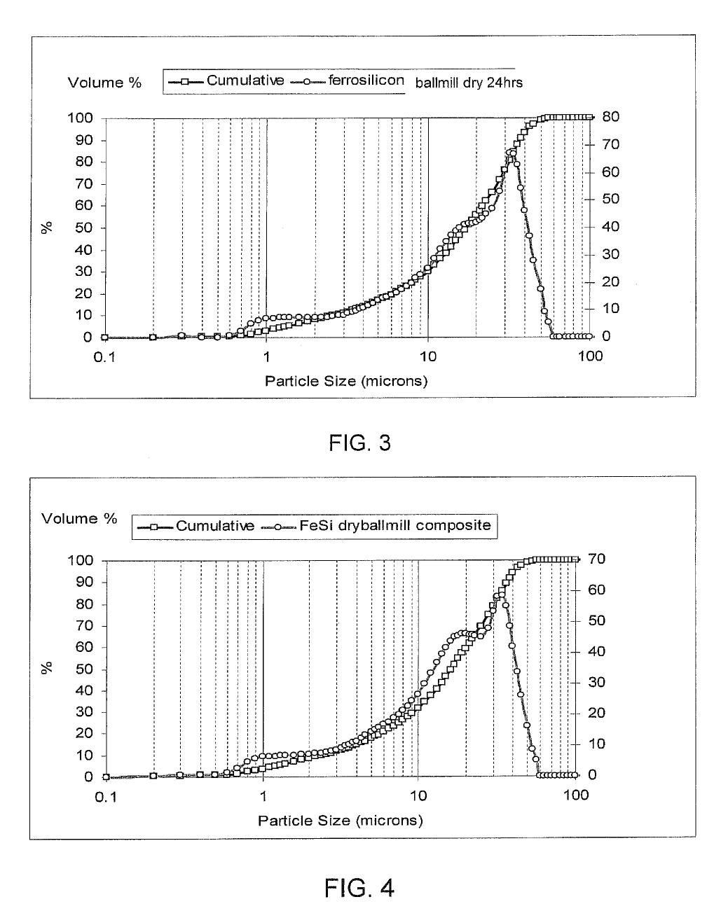

Two samples of crushed ferrosilicon (typical size 2 mm to 5 mm) were placed in separate cylindrical, 20 cm diameter sealed ceramic vessels, each of which had been approximately half-filled with 20 mm to 30 mm diameter alumina (Al₂O₃) balls, and the cylinders were rotated steadily at a rotational speed of 120 rpm for 24 hrs to grind the chips to a powder. The powder was then separated from the balls and screened at 75 microns to get the distributions shown in FIGS. 2 and 3 (Samples 2a and 2b, respectively). The two samples were combined and remeasured for their particle size distributions, which is shown in FIG. 4 (Sample 2c). The particle size distributions as measured by laser light scattering are also shown in Table 1 below.

TABLE 1
Particle Size Distribution and Steepness for Weighting Agent
Made in the Examples

| | | Sample | Sample | Sample |
|---|---|---|---|---|
| | Example | 2a | 2b | 2c |
| | 1 (μm) | (μm) | (μm) | (μm) |
| d 10 | 1.12 | 2.46 | 2.56 | 2.46 |
| d 16 | 1.87 | 4.50 | 4.67 | 4.46 |
| d 25 | 3.62 | 7.66 | 8.06 | 7.58 |
| d 30 | 4.65 | 9.42 | 9.95 | 9.38 |
| d 50 | 9.05 | 16.39 | 17.41 | 16.32 |
| d 70 | 14.12 | 24.84 | 27.07 | 25.28 |
| d 75 | 15.54 | 27.14 | 29.49 | 28.03 |
| d 84 | 18.50 | 31.74 | 33.77 | 32.91 |
| d 90 | 21.14 | 35.66 | 37.32 | 36.69 |
| d30/d70 Steepness | 33 | 38 | 37 | 37 |

### Example 3

One laboratory barrel of an oil-based drilling fluid of density 16 ppg (1.92 g cm⁻³) was prepared using the milled ferrosilicon from Example 2, according to the formulation in Table 2 below:

TABLE 2

| Component | Mass/g |
|---|---|
| Clairsol 370 mineral oil* | 165.2 |
| Water | 45.9 |
| CaCl₂•2H₂O (brine) | 27.5 |
| Emul HT** (emulsifier) | 14.3 |
| Bentone 155*** (organo-clay rheology | 6.6 |
| modifier) | |
| Ca(OH)₂ (lime) | 8.2 |
| FeSi weighting agent | 408 |

*Petrochem Carless
**M.I. Swaco
***Elementis Specialities

The drilling fluid was mixed thoroughly using a high-shear Silverson mixer and its rheology was measured at 80° C. using a Fann 35 rheometer. Rheometer readings were recorded and are given in Table 3 below:

TABLE 3

| Fann rpm | Dial reading |
|---|---|
| 600 | 102 |
| 300 | 58 |
| 200 | 46 |
| 100 | 31 |
| 60 | 25 |
| 30 | 18 |
| 20 | 16 |
| 10 | 13 |
| 6 | 11 |
| 3 | 10 |
| Plastic Viscosity | 44.1 cP |
| Yield Point | 13.8 lb/100 ft² |

The drilling fluid was left standing for several days, at the end of which no measurable sedimentation of the weighting agent had occurred. The solid volume fraction of weighting agent in this sample was 17.4%. In comparison, the solid volume fraction of barite of density 4.2 g cm⁻³ required to reach the same drilling fluid density in this system would be 30.5%, almost twice as much.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations and, unless otherwise indicated, the numerical values set forth in the specific examples are reported as precisely as possible. Any numerical value, however, inherently contains certain errors necessarily resulting from the standard deviation found in their respective testing measurements.

Other embodiments of the invention, including various combinations of the embodiments recited, will be apparent to those skilled in the art from consideration of the specification and practice of the exemplary embodiments disclosed herein. It is intended that the specification and examples be considered as exemplary only, with a true scope and spirit of the invention being indicated by the following claims.

1-15. (canceled)

16. A composition for use in a wellbore, the composition comprising:
a wellbore fluid; and
a weighting agent comprising a ferrosilicon material, wherein iron is present in the ferrosilicon material in an amount equal to or greater than about 50% by weight of the ferrosilicon material.

17. The composition of claim 16, wherein iron is present in the ferrosilicon material in an amount equal to or greater than about 80% by weight of the ferrosilicon material.

18. The composition of claim 16, wherein the density of the ferrosilicon material is equal to or greater than about 5 g/cm³.

19. The composition of claim 16, wherein the wellbore fluid has a fluid density equal to or greater than about 1.5 g/cm³.

20. The composition of claim 16, wherein the wellbore fluid has a fluid density equal to or greater than about 2.0 g/cm³.

21. The composition of claim 16, wherein the wellbore fluid has a solids content equal to or less than about 50% by volume of the composition.

22. The composition of claim 16, wherein the wellbore fluid has a solids content equal to or less than about 30% by volume of the composition.

23. The composition of claim 16, wherein the wellbore fluid has a solids content equal to or less than about 15% by volume of the composition.

24. The composition of claim 16, wherein the ferrosilicon material comprises particles having a d₅₀ ranging from about 2 μm to about 100 μm.

25. The composition of claim 16, wherein the ferrosilicon material comprises particles having a d₅₀ equal to or less than about 10 μm.

26. The composition of claim 16, wherein the ferrosilicon material further comprises titanium in an amount ranging from about 1% to about 5% by weight of the ferrosilicon material.

27. A weighting agent comprising:
a ferrosilicon material, wherein iron is present in the ferrosilicon material in an amount equal to or greater than about 50% by weight of the ferrosilicon material, and wherein the weighting agent is for use in a wellbore fluid composition.

28. The weighting agent of claim 27, wherein iron is present in the ferrosilicon material in an amount equal to or greater than about 80% by weight of the ferrosilicon material.

29. The weighting agent of claim 27, wherein the density of the ferrosilicon material is equal to or greater than about 5 g/cm³.

30. The weighting agent of claim 27, wherein the ferrosilicon material comprises particles having a d₅₀ ranging from about 2 microns to about 100 microns

31. The weighting agent of claim 27, wherein the ferrosilicon material comprises particles having a d₅₀ equal to or less than about 10 microns.

32. A method for reducing the solids content in a wellbore fluid composition, the method comprising:
providing a weighting agent comprising a ferrosilicon material in a wellbore fluid, wherein iron is present in the ferrosilicon material in an amount equal to or greater than about 50% by weight of the ferrosilicon material.

33. The method of claim 32, wherein iron is present in the ferrosilicon material in an amount equal to or greater than about 80% by weight of the ferrosilicon material.

34. The method of claim 32, wherein the composition has a fluid density equal to or greater than about 1.5 g/cm³.

35. The method of claim 32, wherein the composition has a fluid density equal to or greater than about 2.0 g/cm³.

36. The method of claim 32, wherein the composition has a solids content equal to or less than about 50% by volume of the composition.

37. The method of claim 32, wherein the composition has a solids content equal to or less than about 30% by volume of the composition.

38. The method of claim 32, wherein the composition has a solids content equal to or less than about 15% by volume of the composition.

39. The method of claim 32, wherein the ferrosilicon material comprises particles having a d₅₀ ranging from about 2 microns to about 100 microns.

40. The method of claim 32, wherein the ferrosilicon material comprises particles having a d₅₀ equal to or less than about 10 microns.

41. A method for making a weighting agent comprising:
grinding a ferrosilicon material, wherein iron is present in the ferrosilicon material in an amount equal to or greater than about 50% by weight of the ferrosilicon material, and wherein the weighting agent is for use in a wellbore fluid composition.

42. The method for making a weighting agent of claim 41, wherein iron is present in the ferrosilicon material in an amount equal to or greater than about 80% by weight of the ferrosilicon material.

43. A method for treating a wellbore comprising:
providing a wellbore fluid composition in the wellbore, the wellbore fluid composition including a weighting agent comprising a ferrosilicon material, wherein iron is present in the ferrosilicon material in an amount equal to or greater than about 50% by weight of the ferrosilicon material.

44. The method of claim 43, wherein iron is present in the ferrosilicon material in an amount equal to or greater than about 80% by weight of the ferrosilicon material.
